(19) United States
(12) Patent Application Publication
(10) Pub. No.: US 2018/0210872 A1
(43) Pub. Date: Jul. 26, 2018

(54) Input System Having a Communication Model

(71) Applicant: Microsoft Technology Licensing, LLC, Redmond, WA (US)

(72) Inventors: Victoria Newcomb Podmajersky, Seattle, WA (US); Bugra Oktay, Duvall, WA (US); Tracy Childers, Sammamish, WA (US)

(73) Assignee: Microsoft Technology Licensing, LLC, Redmond, WA (US)

(21) Appl. No.: 15/413,180

(22) Filed: Jan. 23, 2017

(51) Int. Cl. G06F 17/27; G06F 3/0488; G06F 3/0482; G06F 17/24; H04L 29/08

(52) U.S. Cl. CPC G06F 17/276; G06F 3/04886; H04L 67/10; G06F 17/24; G06F 3/0482

(57) ABSTRACT

Aspects provided herein are relevant to input systems, such as virtual input elements that allow for entry of text and other input by a user. Aspects can provide the user with, for example, context-aware communication options presented at a sentence or phrase level that are customized to the user's personal communication style.

### BACKGROUND

With the increasing popularity of smart devices, such as smartphones, tablets, wearable computers, smart TVs, set top boxes, game consoles, and Internet-of-things devices, users are entering input to a wide variety of devices. The variety of form factors and interaction patterns for these devices introduce new challenges for users, especially when entering data. Users often enter data using virtual input elements, such as keyboards or key pads, that appear on a device's screen when a user accesses a user interface element that allows the entry of text or other data (e.g., a compose-message field). For example, a smartphone operating system can include a virtual input element (e.g. a keyboard) that can be used across applications running on a device. With these virtual input elements, users enter input letter-by-letter or number-by-number, which can be challenging on small screens or when using directional inputs, such as a gamepad. This input can be more challenging still for individuals that have difficulty selecting and entering input or are using accessibility devices, such as eye trackers or joysticks to provide input.

It is with respect to these and other general considerations that the aspects disclosed herein have been made. Although relatively specific problems may be discussed, it should be understood that the examples should not be limited to solving the specific problems identified in the background or elsewhere in this disclosure.

### SUMMARY

In general terms, this disclosure is relevant to input systems that allow a user to enter data, such as virtual input elements that allow for entry of text and other input by a user. In an example, a virtual input element is disclosed that provides communication options to a user that are context-specific and match the user's communication style.

In one aspect, the present disclosure is relevant to a computer-implemented method for an input system, the method comprising: obtaining user data from one or more data sources, the user data indicative of a personal communication style of a user; generating a user communication model based, in part, on the user data; obtaining data regarding a current communication context, the data comprising data regarding a communication medium; generating a plurality of sentences for use in the current communication context based, in part, on the user communication model and the data regarding the current communication context; and causing the plurality of sentences to be provided to the user for use over the communication medium.

In another aspect, the present disclosure is relevant to a non-transitory computer-readable medium having computer-executable instructions stored thereon that, when executed by a processor, cause the processor to: receive a request for input to a communication medium; obtain a communication context, the communication context comprising data regarding the communication medium; provide the communication context to a communication engine, the communication engine configured to emulate a communication style of a user; receive, from the communication engine, a plurality of sentences generated based on the communication context and the communication style of the user; and make the plurality of sentences available for selection by the user at a user interface as the input to the communication medium.

In yet another aspect, the present disclosure is relevant to a computer-implemented method comprising: obtaining a first plurality of sentences from a communication engine, the first plurality of sentences matching a communication style in a current communication context based on a communication model, the current communication context comprising a communication medium; making the first plurality of sentences available for selection by a user over a user interface; receiving a selection of a sentence of the first plurality of sentences over the user interface; receiving a reword command from the user over the user interface; responsive to receiving the reword command, obtaining a second plurality of sentences based on the selected sentence from the communication engine, the second plurality of sentences matching the communication style in the current communication context based on the communication model and at least one of the second plurality of sentences being different from the first plurality of sentences; and making the second plurality of sentences available for selection by the user over the user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system and method for an input system.

FIG. 2 illustrates an example process for generating communication options using a communication model.

FIG. 3A illustrates an example of the communication model input data.

FIG. 3B illustrates an example of the communication model.

FIG. 4 illustrates an example process for providing communication options for user selection.

FIG. 5A illustrates an example of the communication context.

FIG. 5B illustrates an example of the pluggable sources.

FIG. 6 illustrates an example process for using a framework and input data to emulate a communication style.

FIGS. 7A-7H illustrates an example conversation using an embodiment of the communication system.

FIGS. 8A and 8B illustrate an example implementation of the communication system.

FIG. 9 is a block diagram illustrating example physical components of a computing device with which aspects of the disclosure may be practiced.

FIG. 10A and FIG. 10B are simplified block diagrams of a mobile computing device with which aspects of the present disclosure may be practiced.

FIG. 11 is a simplified block diagram of a distributed computing system in which aspects of the present disclosure may be practiced.

FIG. 12 illustrates a tablet computing device for executing one or more aspects of the present disclosure.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure provides systems and methods relating to providing input to a communications medium. Traditional virtual input systems are often limited to, for example, letter-by-letter input of text or include simple next-word-prediction capabilities. Disclosed embodiments can be relevant to improvements to input systems and methods, and can provide the user with, for example, context-aware communication options presented at a sentence or phrase level that are customized to the user's personal communication style. Disclosed examples can be implemented as a virtual input system. In an example, the virtual input system can be integrated into a particular application into which the user enters data (e.g., a text-to-speech accessibility application). In other examples, the virtual input system can be can separate from the application in which the user is entering data. For instance, the user can select a search bar in a web browser application and the virtual input element can appear for the user to enter data into the search bar. The user can later select a compose message area in a messaging application and the same virtual input element can appear for the user to enter data into the compose message area. Disclosed examples can also be implemented as part of a spoken interface, for example as part of a smart speaker system or intelligent personal assistant (e.g., MICROSOFT CORTANA). For example, the spoken interface may allow the user to respond to a message and provide example communication options for responding to those messages by speaking the options aloud or otherwise presenting them to the user. The user can then tell the interface which option the user would like to select.

Disclosed embodiments can also provide improved accessibility options for users having one or more physical or mental impairments who may rely on eye trackers, joysticks, or other accessibility devices to provide input. By selecting input at a sentence level rather than at a letter-by-letter level, users can enter text more quickly. It can also reduce a language barrier by reducing the need for a user to enter input using correct spelling or grammar. Improvements to accessibility can also help users entering input while having only one hand free.

In some examples, a communication input system can predict what a user would want to say (e.g., in sentences, words, or using pictorials) in a particular circumstance, and present these predictions as options that the user can choose among to carry on a conversation or otherwise provide to a communication medium. The communication input system can include a communication engine that leverages a communication context and a communication model, as well as pluggable sources, to generate communication options for a user that approximate what the user would communicate given particular circumstances and the user's own communication style. A user can give the input system access to data regarding the user's style of communicating so the input system can generate a communication model for the user that can be used to generate a user-specific communication style. A user can also give the input system access to a communication context with which the communication engine can generate context-appropriate communication options.

These communication options can include sentences. As used herein the word “sentence” describes complete sentences that convey a complete thought even if missing elements are provided by context. For example, sentences can include pro-sentences (e.g., “yes” or “no”) and minor sentences (e.g., “hello” or “wow!”). In an example, the communication context is a conversation in a messaging app, and a party to the communication asks the user “Are you free for lunch tomorrow?” A complete sentence response can include “I am free”, “What are you doing today?”, and “I'll check.” A complete sentence response can also include “Yes”, “Can't tomorrow” and “Free” because context can fill in missing elements (e.g., the subject “I” in the phrase “Can't tomorrow”). A sentence need not include a subject and a predicate. A sentence also need not begin with a capital letter or end with a terminal punctuation mark.

The communication options need not be limited to text and can also include other communication options including emoji, emoticons, or other pictorial options. For example, if a user is responding to the question “How's the weather?”, the communication engine can present pictorial options for responding, including a pictorial of a sun, a wind emoji, and a picture of clouds. In an example, the communication options can also include individual words as input, even if the individual words do not form a complete sentence.

Communication options can also include packages of information from pluggable sources. In an example, the input system can be linked to weather programs, mapping programs, local search programs, calendar programs and other programs to provide packages of information. For example, the user can be responding to the question “Where are you?” and the input system can load from a mapping program a map showing the user's current location with which the user can respond. The map can, but need not, be interactive.

The communication engine can further rephrase options upon request to provide additional options to the user. The input system can further allow the user to choose between different communication option types and levels of granularity, such as sentence level, word level, letter level, pictorial, and information packages. In some examples, only one communication option type is displayed at a time (e.g., only sentence level options are available for selection until the user chooses a different level at which to display options). In other examples, different types of communication options can be displayed together (e.g., a mix of sentences and non-sentence words).

As the user continues to communicate using the input system, the input system can learn the user's preferences and phrasing over time. The input system can use this information to present more personal options to the user.

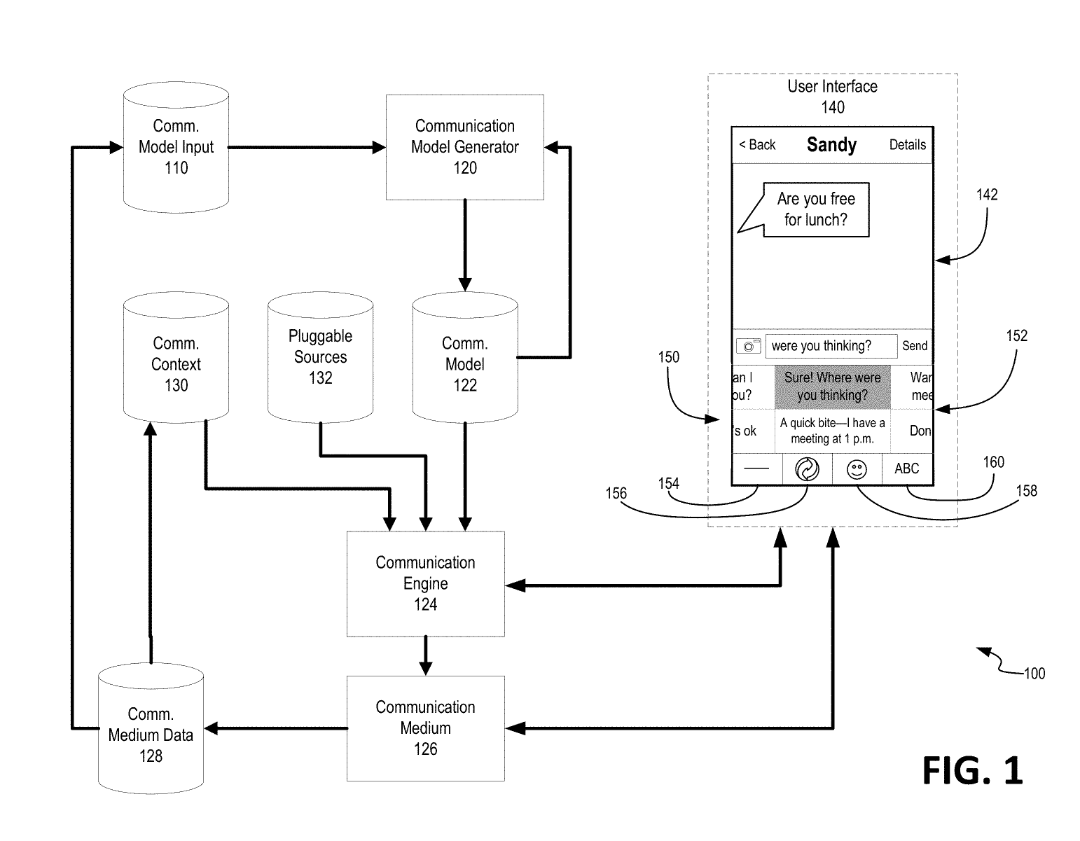

FIG. 1 illustrates an overview of an example input system 100 and a method of use. The input system 100 can include communication model input data 110, a communication model generator 120, a communication model 122, a communication engine 124, a communication medium 126, communication medium data 128, communication context data 130, pluggable sources 132, and a user interface 140.

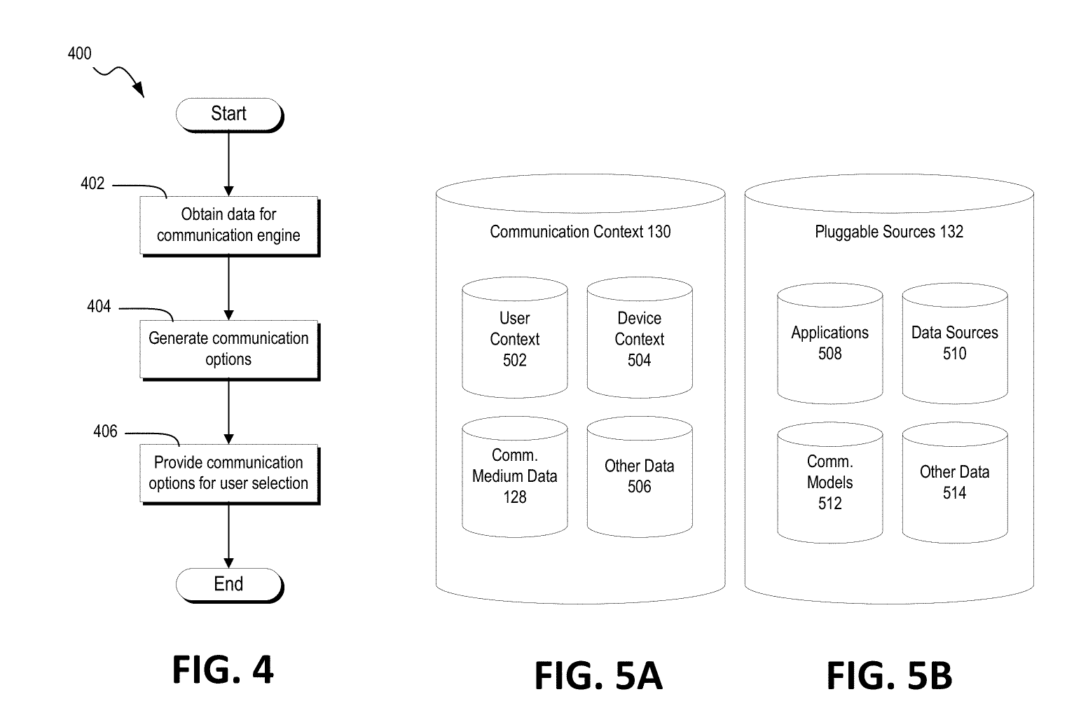

The communication model 122 is a model of a particular style or grammar for communicating that can be used to generate communications. The communication model 122 can include syntax data, vocabulary data, and other data regarding a particular manner of communicating (see, e.g., FIG. 3A and associated disclosure).

The communication model input data 110 is data that can be used by the communication model generator 120 to construct the communication model 122. The communication model input data 110 can include information regarding or indicative of a specific style or pattern of communication, including information regarding grammar, syntax, vocabulary, and other information (see, e.g., FIG. 3 and associated disclosure).

The communication model generator 120 is a program module that can be used to generate or update a communication model 122 using communication model input data 110.

The communication engine 124 is a program module that can be used to generate communication options for selection by the user. The communication engine 124 can also interact with and manage the user interface 140, which can be used to present the communication options to the user and to receive input from the user regarding the displayed options and other activities. The communication engine 124 can also interact with the communication medium 126 over which the user would like to communicate. For example, the communication engine 124 can provide communication options that were selected by the user to the communication medium 126. The communication engine 124 can also receive data from the communication medium 126.

The communication medium 126 is a medium over, with, or to which the user can communicate. For example, the communication medium 126 can include software that enables person to initiate or respond to data transfer, including but not limited to a messaging application, a search application, a social networking application, a word processing application, and a text-to-speech application. For example, communication mediums 126 can include messaging platforms, such as text messaging platforms (e.g., Short Message Service (SMS) messaging platforms, Multimedia Messaging Service (MMS) messaging platforms, instant messaging platforms (e.g., MICROSOFT SKYPE, APPLE IMESSAGE, FACEBOOK MESSENGER, WHATSAPP, TENCENT QQ, etc.), collaboration platforms (e.g., MICROSOFT TEAMS, SLACK, etc.), game chat clients (e.g., in-game chat, XBOX SOCIAL, etc.), and email. Communication mediums 126 can also include data entry fields (e.g., for entering text), such as those found on websites (e.g., a search engine query field), in documents, in applications, and elsewhere. For example, a data entry field can include a field for composing a social media posting. Communication mediums 126 can also include accessibility systems, such as text-to-speech programs.

The communication medium data 128 is information regarding the communication medium 126. The communication medium data 128 can include information regarding both current and previous uses of the communication medium 126. For example, where the communication medium 126 is a messaging application, the communication medium data 128 can include historic message logs (e.g., the contents of previous messaging conversation and related metadata) as well as information regarding a current context within the messaging communication medium 126 (e.g., information regarding a current person the user is messaging). The communication medium data 128 can be retrieved in various ways, including but not limited to accessing data through an application programming interface of the communication medium 126, through screen capture software, and through other sources. The communication medium data 128 can be used as input directly into the communication engine 124 or combined with other communication context data 130.

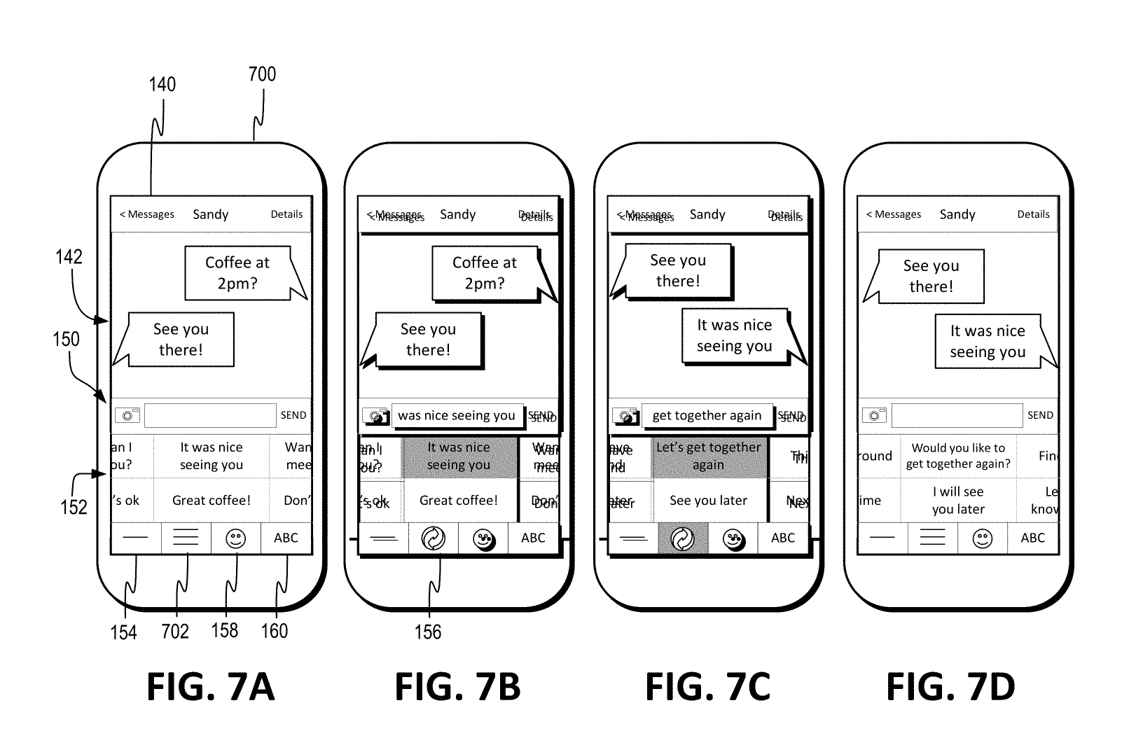

The communication context data 130 is information regarding the context in which the user is using the input system 100. For example, the communication context data can include, but need not be limited to context information regarding the user, context information regarding a device associated with the input system, the communication medium data 128, and other data (see, e.g., FIG. 5A and associated disclosure). The communication context data 130 need not be limited to data regarding the user. The communication context data 130 can include information regarding others.

The pluggable sources 132 include sources that can provide input data for the communication engine 124. The pluggable sources 132 can include, but need not be limited to, applications, data sources, communication models, and other data (see, e.g., FIG. 5B and associated disclosure).

The user interface 140 can include a communication medium user interface 142, a communication engine user interface 150. The communication medium user interface 142 is a user interface for the communication medium 126. As illustrated in FIG. 1, the communication medium 126 is a messaging client and the communication medium user interface 142 includes user interface elements specific to that kind of communication medium. For example, the communication medium user interface displays chat bubbles, a text input field, a camera selection button, a send button, and other elements. Where the communication medium 126 is a different kind of medium, the communication medium user interface 142 can change accordingly.

The communication engine user interface 150 is a user interface for the communication engine 124. In the illustrated example, the input system 100 is implemented as a virtual input system that is a separate program from the communication medium 126 that can be used to provide input to the communication medium 126. The communication engine user interface 150 can include an input selection area 152, a word entry input selector 154, a reword input selector 156, a pictorial input selector 158, and a letter input selector 160.

The input selection area 152 is a region of the user interface by which the user can select communication options generated by the communication engine 124 that can be used as input for the communication medium 126. In the illustrated example, the communication options are displayed at a sentence level and can be selected for sending over the communication medium 126 as part of a conversation with Sandy. The input selection area 152 represents the communication options as sentences within cells of a grid. Two primary cells are shown in full and four additional cells are shown on either side of the primary cells. The user can access these four additional options by swiping the input selection area 152 or by another means. In an example, the user can customize the display of the input selection area 152 to include, for instance, a different number of cells, a different size of the cells, or display options other than cells.

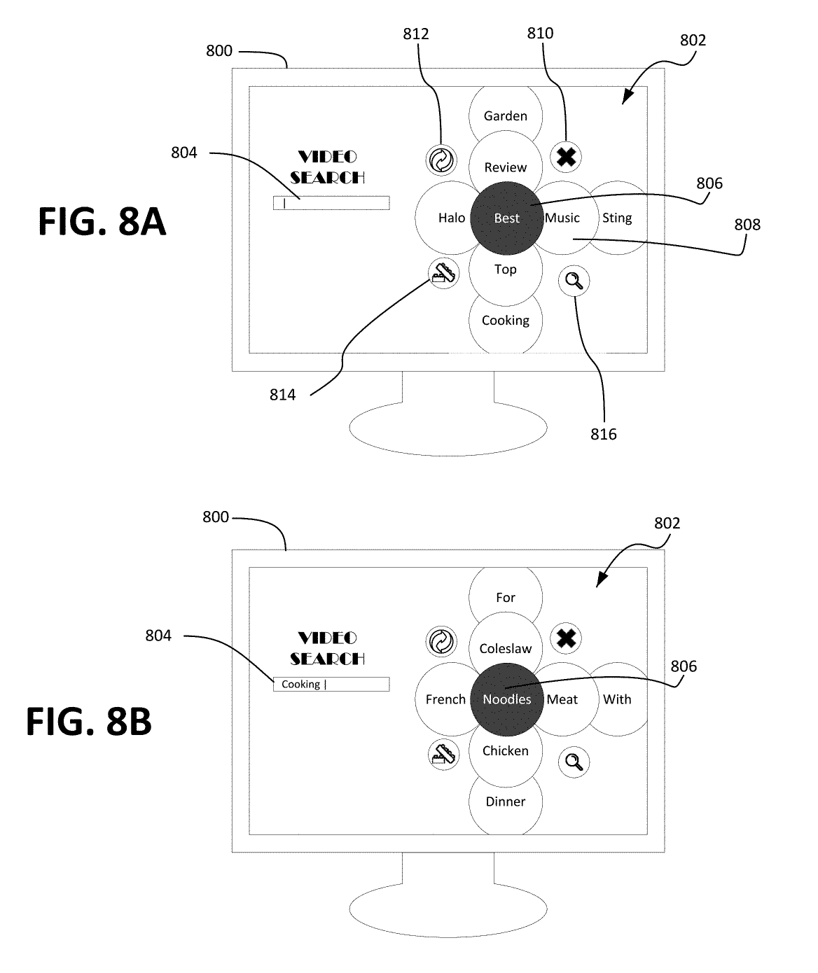

The word entry input selector 154 is a user interface element for selecting the display of the communication options at a word level (see, e.g., FIG. 7F). The reword input selector 156 is a user interface element for rephrasing the currently-displayed communication options (see, e.g., FIG. 7C and FIG. 7D). The pictorial input selector 158 is a user interface element for selecting the display of communication options at pictorial level, such as using images, ideograms, emoticons, or emoji (see, e.g., FIG. 7G). The letter input selector 160 is a user interface element for selecting the display of communication options at an individual letter level.

Other user interfaces and user interface elements may be used. For example, the user interface 140 is illustrated as being a type of user interface that may be used with, for instance, a smartphone, but the user interface 140 could be a user interface for a different kind of device, such as a smart speaker system or an accessibility device that may interact with a user in a different manner. For example, the user interface 140 could be a spoken user interface for a smartphone (e.g., as an accessibility feature). The input selection area 152 could then include the smartphone reading the options aloud to the user and the user telling the smartphone which option to select. In an example, the input system 100 need not be limited to a single device. For example, the user can have the input system 100 configured to operate across multiple devices (e.g., a cell phone, a tablet, and a gaming console). In an example, each device has its own instance of the input system 100 and data is shared across the devices (e.g., updates to the communication model 122 and communication context data 130). In an example one or more of the components of the input system 100 are stored on a server remote from the device and accessible from the various devices.

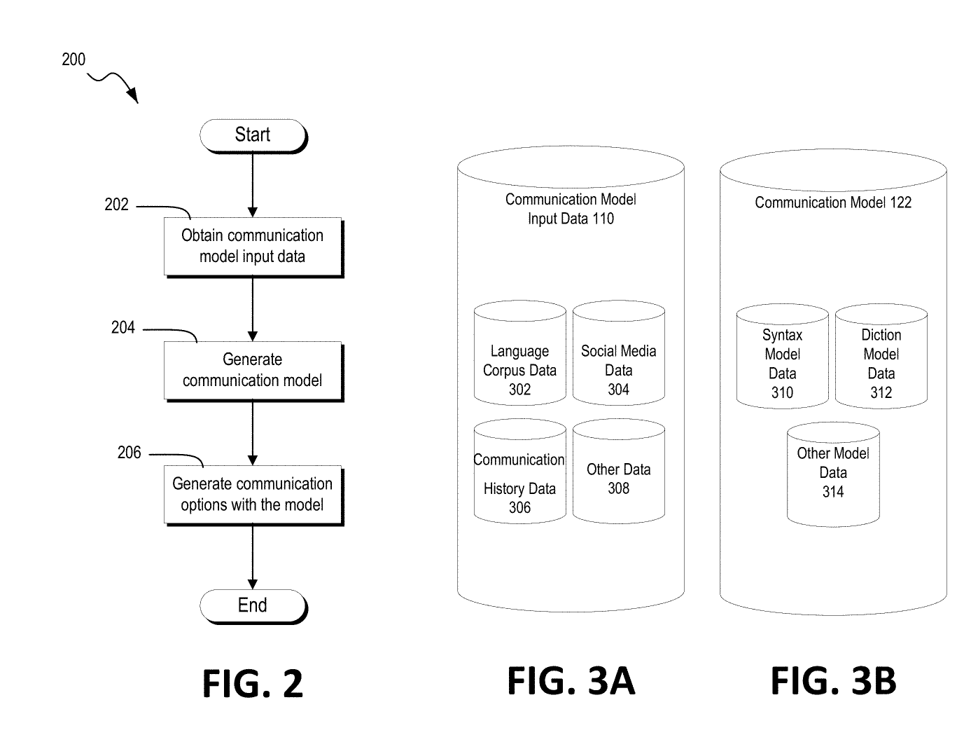

FIG. 2 illustrates an example process 200 for generating communication using a communication model 110. The process 200 can begin with operation 202. Operation 202 relates to obtaining communication model input data 110. The communication model generator 120 can obtain communication model input data 110 from a variety of sources. In an example, the communication model input data 110 can be retrieved by using an application programming interface (API) of a program storing data, by scraping data, by using data mining techniques, by downloading packaged data, or in other manners. The communication model input data 110 can include data regarding the user of the input system 100, data regarding others, or combinations thereof. Examples of communication model input data 110 types and sources are described with regard to FIG. 3A.

FIG. 3A illustrates an example of the communication model input data 110, which can include language corpus data 302, social media data 304, communication history data 306, and other data 308. The language corpus data 302 is a collection of text data. The language corpus data 302 can include text data regarding the user of the input system, a different user, or other individuals. The language corpus data 302 can include but need not be limited to, works of literature, news articles, speech transcripts, academic text data, dictionary data, and other data. The language corpus data 302 can originate as text data or can be converted to text data from another format (e.g., audio). The language corpus data 302 can be unstructured or structured (e.g., include metadata regarding the text data, such as parts-of-speech tagging). In an example, the language corpus data 302 is organized around certain kinds of text data, such as dialects associated with particular geographic, social, or other groups. For example, the language corpus data 302 can include a collection of text data structured around people or works from a particular country, region, county, city, or district. As another example, the language corpus data 302 can include a collection of text data structured around people or works from a particular college, culture, sub-culture, or activity group.

The language corpus data 302 can be used by the communication model generator 120 in a variety of ways. In an example, the language corpus data 302 can be used as training data for generating the communication model 122. The language corpus data 302 can include data regarding people other than the user but that may share one or more aspects of communication style with the user. This language corpus data 302 can be used to help generate the communication model 122 for the user and may be especially useful where there is a relative lack of communication data for the user generally or regarding specific aspects of communication.

The social media data 304 is a collection of data from social media services, including but not limited to, social networking services (e.g., FACEBOOK), blogging services (e.g., TUMBLR), photo sharing services (e.g., SNAPCHAT), video sharing services (e.g., YOUTUBE), content aggregation services (e.g., PINTEREST), social messaging platforms, social network games, forums, and other social media services or platforms. The social media data 304 can include postings by the user or others, such as text, video, audio, or image posts. The social media data 304 can also include profile information regarding the user or others. The social media data 304 can include public or private information. In an example, the private information is accessed with the permission of the user in accordance with a defined privacy policy. Where the social media data 304 of others is used, it can be anonymized, or otherwise used in a manner in which the data is not directly exposed to the user. The social media data 304 can be used to gather examples of how the user communicates and can be used to generate the communication model 122. The social media data 304 can also be used to learn about the user's interests, as well as life events for the user. This information can be used to help generate communication options. For example, if the user enjoys running, and the communication engine 124 is generating options for responding to the question “what would you like to do this weekend?”, the communication engine 124 can use the knowledge that the user enjoys running and can incorporate running into a response option.

The user communication history data 306 includes communication history data gathered from communication mediums, including messaging platforms (e.g., text messaging platforms, instant messaging platforms, collaboration platforms, game chat clients, and email platforms). This information can include the content of communications (e.g., conversations) over these platforms, as well as associated metadata. The user communication history data 306 can include data gathered from other sources as well. In an example, the private information is accessed with the permission of the user in accordance with a defined privacy policy. Where the communication history data 306 of others is used, it can be anonymized, or otherwise used in a manner in which the data is not directly exposed to the user.

The other data 308 can include other data that may be used to generate a communication model 122 for a user. In an example, the input system 100 can prompt the user to provide specific information regarding a style of speech. For example, the input system can walk the user through a style calibration quiz to learn the user's communication style. This can include asking the user to choose between different responses to communication prompts. The other data 308 can also include user-provided feedback. For example, when the user is presented with communication options, and instead chooses to reword the options or provide input through the word, pictorial, or other input processes, the associated information can be used to provide more-accurate input in the future. The other data 308 can also include a communication model. The other data 308 can include a search history of the user.

Returning to FIG. 2, after the communication model input data 110 is obtained in operation 202, the flow can move to operation 204, which relates to generating the communication model 122. The communication model 122 can be generated by the communication model generator 120 using the communication model input data 110. The communication model 122 can include one or more of the aspects shown and described in relation to FIG. 3B.

FIG. 3B illustrates an example of the communication model 122, including syntax model data 310, diction model data 312, and other model data. The syntax model data 310 is data for a syntax model, describing how the syntax of a communication can be formulated, such as how words and sentences are arranged. For example, where the communication model 122 is a model of the communication for a user of the input system, then the syntax model data 310 is data regarding the user's use of syntax. The syntax model data 310 can include data regarding the use of split infinitives, passive voice, active voice, use of the subjunctive, ending sentences with propositions, use of double negatives, dangling modifiers, double modals, double copula, conjunctions at the beginning of a sentence, appositive phrases, and parentheticals, among others. The communication model generator 120 can analyze syntax information contained within the communication model input data 110 and develop a model for the use of syntax according to the syntax data.

The diction model data 312 includes information describing the selection and use of words. For example, the diction model data 312 can define a particular vocabulary of words that can be used, including the use of slang, jargon, profanity, and other words. The diction model data 312 can also describe the use of words common to particular dialects. For example, the dialect data can describe regional dialects (e.g., British English) or activity-group dialects (e.g., the jargon used by players of a particular video game).

Other model data 314 can include other data relevant to the construction of communication options. The other model data 314 can include, for example, typography data (e.g., use of exclamation marks, the use of punctuation with quotations, capitalization, etc.) and pictorial data (e.g., when and how the user incorporates emoji into communication). The other model data 314 can also include data regarding qualities of how the user communicates, including levels of formality, verbosity, or other attributes of communication.

The communication model 122 and its submodels can generated in a variety of ways. For example, model data can be formulated by determining the frequency of the use of particular grammatical elements (e.g., syntax, vocabulary, etc.) within the communication model input data 110. For example, the input data can be analyzed to determine the relative use of active and passive voice. The model data can include, for example, information regarding the percentage of time that a particular formulation is used. For example, it can be determined that active voice is used in 80% of situations where it is possible to use active voice and in 20% of situations where it is possible to use passive voice. The syntax model data can also associate contexts in which particular syntax is used. For example, based on the communication model input data 110, it can be determined that double negatives are more likely to be used when used with past tense constructions than with future tense constructions. The communication model data can also be formulated as heuristics for scoring particular communication options based on particular context data. The model data can also be formulated as a machine learning model.

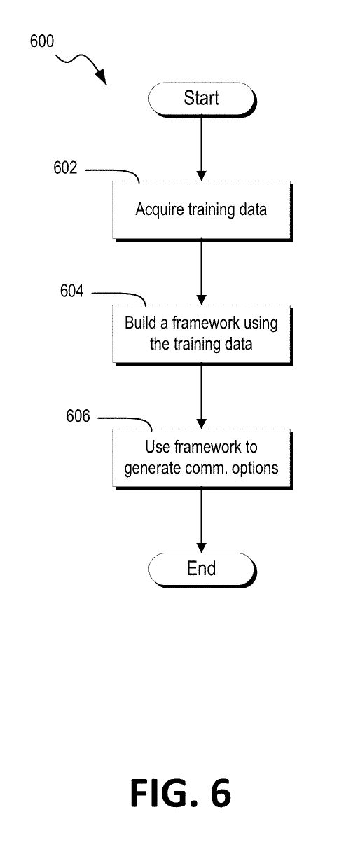

Returning to FIG. 2, after the communication model 122 is generated in operation 206, the flow moves to operation 206, which relates to generating communication options with the communication model 122. The communication options can be generated in a variety of ways, including but not limited to those described in relation to FIG. 4.

FIG. 4 illustrates an example process 400 for providing output for user selection. The process 400 can begin with operation 402. Operation 402 relates to obtaining data for the communication engine 124. Obtaining data for the communication engine 124 can include obtaining data for use in generating communication options. The data can include, but need not be limited to one or more communication models 122, pluggable sources data 132, and communication context data 130. Examples of communication context data 130 is described in relation to FIG. 5A and examples of pluggable sources data is described in relation to FIG. 5B.

FIG. 5A illustrates an example of the communication context data 130. The communication context data 130 can be obtained from a variety of sources. The data can be obtained using data mining techniques, application programming interfaces, data scraping, and other methods of obtaining data. The communication context data 130 can include communication medium data 128, user context data 502, device context data 504, and other data 506.

The user context data 502 includes data regarding the user and the environment around the user. The user context data 502 can include, but need not be limited to location data, weather data, ambient noise data, activity data, user health data (e.g., heart rate, steps, exercise data, etc.), current device data (e.g., that the user is currently using a phone), recent social media or other activity history. The user context data 502 can also include the time of day (e.g., which can inform the use of “good morning” or “good afternoon”) and appointments on the user's calendar, among other data.

The device context data 504 includes data about the device that the user is using. The device context data 504 can include, but need not be limited to, battery level, signal level, application usage data (e.g., data regarding applications being used on the device on which the input system 100 is running), and other information.

The other data 506 can include, for example, information regarding a person with whom the user is communicating (e.g., where the communication medium is a messaging platform or a social media application). The other data can also include cultural context data. For example, if the user receives the message “I'll make him an offer he can't refuse”, the communication engine 124 can use the cultural context data to determine that the message is a quotation from the movie “The Godfather”, which can be used to suggest communication options informed by that context. For example, the communication engine 124 can use one or more pluggable sources 132 to find other quotes from that or other movies.

FIG. 5B illustrates an example of the pluggable sources data 132. The pluggable sources data 132 can include applications 508, data sources 510, communication models 512, and other data 514.

The applications 508 can include applications that can be interacted with. The applications 508 can include applications running on the device on which the user is using the input system 100. This can include, for example, mapping applications, search applications, social networking applications, camera applications, contact applications, and other applications. These applications can have application programming interfaces or other mechanisms through which the input system 100 can send or receive data. The applications can be used to extend the capabilities of the input system, for example, by allowing the input system 100 to access a camera of the device to take and send pictures or video. As another example, the applications can be used to allow the input system 100 to send location information (e.g., the user's current location), local business information (e.g., for meeting at a particular restaurant), and other information. In another example, the applications 508 can include modules that can be used to expand the capability of the communication engine 124. For example, the application can be an image classifier artificial intelligence program that can be used to analyze and determine the contents of an image. The communication engine 124 can use such a program to help generate communication options for contexts involving pictures (e.g., commenting on a picture on social media or responding to a picture message sent by a friend).

The data sources 510 that the communication engine 124 can draw from to formulate communication options. For example, the data sources can include social networking sties, encyclopedias, movie information databases, quotation databases, news databases, event databases, and other sources of information. The data sources 510 can be used to expand communication options. For example, where the user is responding to the message: “did you watch the game last night?”, the communication engine 124 can deduce which game is meant by the message and appropriate options for responding. For example, the communication engine 124 can use a news database as a data source to determine what games were played the previous night. The communication engine 124 can also use social media and other data to determine which of those games may be the one being referenced (e.g., based on whether it can be determined which team the user is a fan of). Based on this and other information, it can be determined which team the message was referencing. The news database can further be used to determine whether that team won or lost and generate appropriate communication options. As another example, the data sources can include social media data, which can be used to determine information regarding the user and the people that the user messages. For example, the communication engine 124 can be generating communication options for a “cold” message (e.g., a message that is not part of an ongoing conversation). The communication engine 124 can use social media data to determine whether there are any events that can be used to personalize the message options, such as birthdays, travel, life events, and others.

The communication models 512 can include communication models other than the current communication model 122. The communication models 512 can supplement or replace the current communication model 122. This can be done to localize a user's communication. For example, a user traveling to a different region or communicating with someone from a different region may want to supplement his or her current communication model 122 with a communication model specific to that region to enhance communications to fit with regional dialects and shibboleths. As another example, a user could modify the current communication model 122 with a communication model 512 of a celebrity, author, fictional character, or another.

Returning to FIG. 4, operation 404 relates to generating communication options. The communication engine 124 can use the data obtained in operation 402 to generate communication options. For example, the communication engine 124 can use the communication medium data 128 to determine information regarding a current context in which the communication options are being used, this can include, for example, the current place in a conversation (e.g., whether the communication options are being used in the beginning, middle, or end of a conversation), a relationship between the user and the target of the communication (e.g., if the people are close friends, then the communication may have a more informal tone than if the people have a business relationship), data regarding the person that initiated the conversation, among others.

The communication options can also be generated based on habits of the user. For example, if the communication context data 130 indicates that the user has a habit of watching a particular television show and has missed an episode, the communication engine 124 can generate options specific to that situation. For example, the communication options could include “I haven't seen this week's episode of [hit TV show]. Please don't spoil it for me!” or, where the communication engine 124 detects that the user is searching for TV shows to watch, the communication engine 124 could choose the name of that TV show as an option.

In another example, where the communication medium 126 is, for example, a video game chat client, the communication medium data 128 can include information regarding the video game being played. For example, the communication engine 124 can receive communication medium data 128 indicating that the user won or lost a game and can generate response options accordingly. Further, the communication model 122 may include information regarding how players of that game communicate (e.g., particular, game-specific jargon) and can use those specifics to generate even-more applicable communication options.

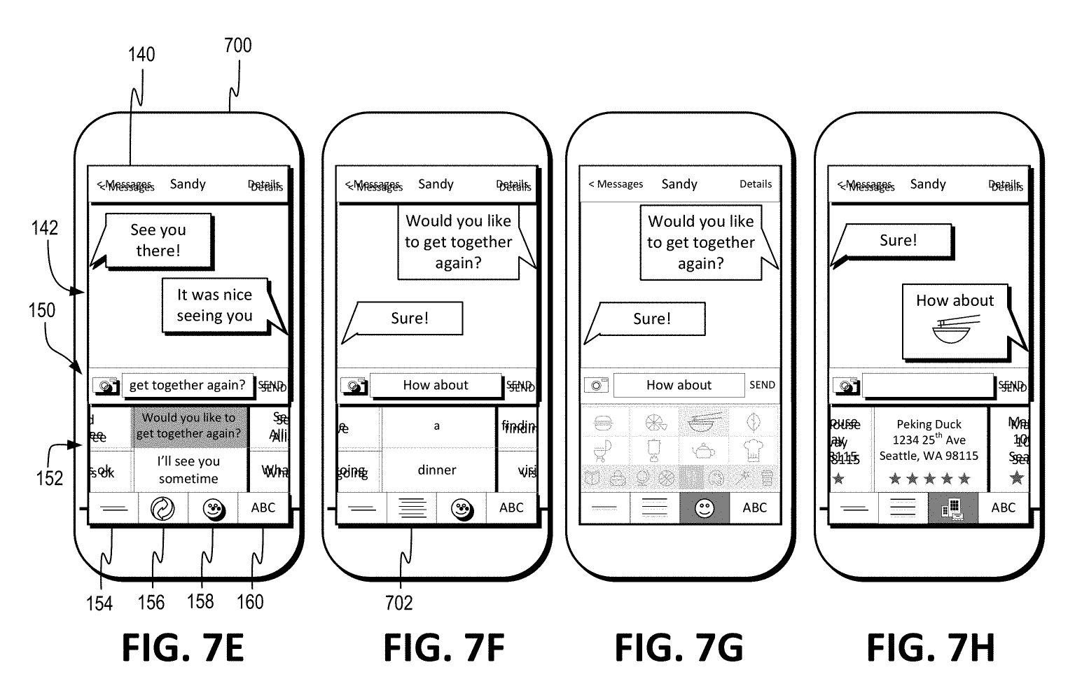

The communication options can be generated in a variety of ways. In an example, the communication engine can retrieve the communication context data 130 and find communication options in the communication model 122 that match the communication context data 130. For example, the communication context data 130 can be used to determine what category of context the user is communicating in (e.g., whether the user received an ambiguous greeting, an invitation, a request, etc.). The communication engine 124 can then find examples of how the user responded in the same or similar contexts and use those responses as communication options. The communication engine 124 can also generate communication options that match the category of communication received. For example, if the user receives a generic, ambiguous greeting, the communication engine 124 can generate or select from communication options that also fit the generic, ambiguous greeting category. In another example, the communication options can be generated using machine learning techniques, natural language generators, Markov text generators, or other techniques, including techniques used by intelligent personal assistants (e.g., MICROSOFT CORTANA) or chatbots. The communication options can also be made to fit with the communication model 122. In an example, this can include generating a large amount of potential communication options and then ranking them based on how closely they match the communication model 122. In another example, the communication model 122 can be used as a filter to remove communication options that do not match the modeled style. In an example, the data obtained in operation 402 can be used to generate a framework, which is used to generate options. An example of a method for generating communication options using a framework is described in relation to FIG. 6.

FIG. 6 illustrates an example process 600 for using a framework generate communication options. Process 600 begins with operation 602, which relates to acquiring training data. The training data can include the data obtained for the communication engine in operation 402, including the communication model and the pluggable sources 132. The training data can also include other data, including but not limited to the communication model input data 110. In an example, the training data can include the location of data containing training examples. In an example, the training data can be classified, structured, or organized with respect to particular communication contexts. For example, the training data can describe the particular manner of how the user would communicate in particular contexts (e.g., responding to a generic greeting or starting a new conversation with a friend).

Operation 604 relates to building a framework using the training data. The model can be built using one or more machine learning techniques, including but not limited to neural networks and heuristics. Operation 606 relates to using the framework and the communication context data 130 to generate communication options. For example, the communication context data 130 can be provided as input to the trained framework, which, in turn, generates communication options.

Returning to FIG. 4, operation 406 relates to providing output for user selection. The communication engine can provide communication options for selection by the user, for example, at the input selection area 152 of the communication engine user interface 150. The communication engine 124 can provide all of the outputs generated or a subset thereof. For example, the communication engine 124 can use the communication model 122 to rank the generated communication outputs and select the top n highest matches, where n is the number of communication options capable of being displayed as part of the input selection area 152.

FIGS. 7A-7H illustrates an example use of an embodiment of the input system 100 during a conversation between the user and a person named Sandy. In the illustrated embodiment, on the display of a smartphone 700 there is the communication medium user interface 142 for a messaging client communication medium 126, as well as the communication engine user interface 150, which can be used to provide input for the communication medium 126 as selected by the user.

In the example, the user and Sandy just met for coffee and the user is going to send a message to Sandy. The user opens up a messaging app on the smartphone 700 and sees the user interface 140 of FIG. 7A.

FIG. 7A shows an example in which the communication engine user interface 150 can be implemented as a virtual input element for a smartphone. The communication engine user interface 150 appears and allows the user to select communication options to send to Sandy. The input system 100 uses the systems or methods described herein to generate the communication options. For example, the user previously granted the system access to the user's conversation histories, search histories, and other data, which the communication model generator 120 used to create a communication model 122 for the user. This communication model 122 is used as input to the communication engine 124, which also takes as input some pluggable sources 132, as well as the communication context data 130. Here, the communication context data 130 includes communication medium data 128 from the communication medium 126. In this example, the user gave the input system 100 permission to access the chat history from the messaging app. The user also gave the input system 100 permission to access the user's calendar and the user's calendar data can also be part of the communication context data 130, along with other data. With the communication context data 130, pluggable sources 132, and communication model 122 as input, the communication engine 124 can generate communication options that match not only the user's communication style (e.g., as defined in the communication model 122), but also the current communication context (e.g., as defined in the communication context data 130).

In the example, the communication engine 124 can understand, based on the user's communication history with Sandy and the user's calendar, that the user and Sandy just met for coffee. Based on this data, the communication engine 124 generates message options for the user that match the user's style based on the communication model 122. The communication model 122 indicates that in circumstances where the user is messaging someone after meeting up with them, the user often says “It was nice seeing you”. The communication engine 124, detecting that the message meets the circumstances, adds “It was nice seeing you” to the message options. The communication model 122 also indicates that the user's messages often discuss food and drinks at restaurants or coffee shops. The communication model 122 further indicates that the user's grammar includes the use of short sentences with the subject supplied by context, especially with an exclamation mark. Based on this input, the communication engine 124 generates “Great coffee!” as a message option. This process of generating message options based on the input to the communication engine 124 continues until a threshold number of messages are made. The options are then displayed in the input selection area 152 of the user interface 140. The communication engine 124 determined that “It was nice seeing you” and “Great coffee!” best fit the circumstances and the user's communication model 122 and are placed in a prominent area of the input selection area 152.

In FIG. 7B, the user sees the options displayed in the input selection area 152 and chooses “It was nice seeing you.” With the phrase selected by the user, the phrase is sent to the communication medium 126, which puts the phrase in a text field of the user interface 142. The user can send the message by hitting the send button of the user interface 142. In addition, the phrase input selector 702 turns into a reword input selector 156. The user likes the selected phrase and selects the send button on the communication medium user interface 142 to send the message.

After sending the message, the communication engine 124 receives an updated communication context data 130 that indicates that the user sent the message “It was nice seeing you.” This information is sent as communication model input data 110 to the communication model generator 120 to update the user's communication model 122. The information is also sent to the communication engine as communication context data 130, which is provided as input to the communication engine 124 along with the pluggable sources 132 and the updated communication model 122. Based on these inputs, the communication engine generates new communication options for the user.

FIG. 7C shows the newly generated communication options for the user in the input selection area 152. The user likes the phrase “Let's get together again” but wants to express the sentiment a little differently, so the user selects the reword input selector 156. The communication engine 124 receives the indication that the user wanted to rephrase the expression “Let's get together again.” The communication engine 124 then generates communication options with similar meaning to “Let's get together again” that also fit the user's communication style. This information is also sent as communication model input data 110 to the communication model generator 120 to generate an updated communication model 122 to reflect that the user wanted to rephrase the generated options in that circumstance.

FIG. 7D shows the input selection area 152 after the communication engine 124 generated rephrased options, including “Would you like to get together again?” and “I will see you later.”

In FIG. 7E, the user selects “Would you like to get together again?” and sends the message.

In FIG. 7F, Sandy replies with “Sure!” The communication engine 124 generates response options based on this updated context, but the user decides to send a different message. The user selects the word entry input selector 154, and the communication engine 124 generates words to populate the input selection area 152. The communication engine 124 beings by generating single words that the user commonly uses to start sentences in similar contexts. The communication engine 124 understands that sentence construction is different from using phrases. The user chooses “How” and the communication engine generates new words to follow “How” that match the context and the user's communication style. The user selects “about.”

In FIG. 7G, the user does not see a word that expresses how the user wants to convey the message, so the user chooses the pictorial input selector 158 and the communication engine 124 populates the input selection area 152 with pictorials that match the communication context data 130 and the user's communication model 122. The user selects and sends an emoji showing chopsticks and a bowl of noodles.

In FIG. 7H, the communication engine 124, based on the communication context data 130, understands that the user is suggesting that they go eat somewhere, so the communication engine populates the input selection area 152 with location suggestions that are appropriate to the context based on the emoji showing chopsticks and a bowl of noodles. The communication engine 124 gathers these suggestions through one of the pluggable sources 132. The user has an app installed on the smartphone 700 that offers local search and business rating capabilities. The pluggable sources 132 can include an application programming interface (API) for this local search and business rating app. The communication engine, detecting that the user may want to suggest a local noodle restaurant, uses the pluggable source to load relevant data from the local search and business rating application and populate the input selection area for selection by the user.

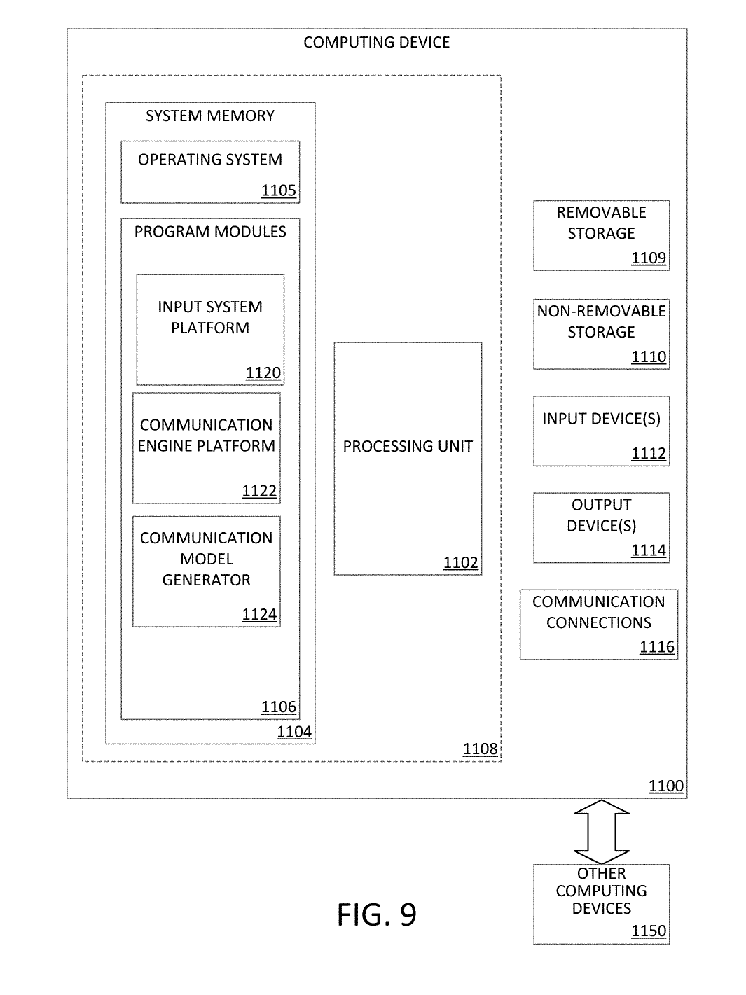

FIGS. 8A and 8B illustrate an example implementation showing a screen 800 showing a user interface 802 through which the user can use the input system 100 to find videos on a video search communication medium 804. The user interface 802 includes user interface elements for the communication medium 804, including a search text entry field. The user interface 802 also includes user interface elements for the input system 100. These user interface elements can include a cross-shaped arrangement of selectable options. As illustrated, the options are single words generated using the communication engine 124, but in other examples, the options can be phrases or sentences. Based on the context, the communication option having the highest likelihood of being what the user would like to input is placed at the center of the arrangement of options. As illustrated, the most likely option is “Best,” which is a currently-selected option 806, other options, such as “Music” or “Review” are unselected options 808. Where the screen 800 is a touchscreen, the user can navigate among or select the options by, for example, tapping, flicking, or swiping. In another example, the user can navigate among the options using a directional pad, keyboard, joystick, remote control, gamepad, gesture control, or other input mechanism.

The user interface 802 also includes a cancel selector 810, a reword option 812, a settings selector 814, and an enter selector 816. The cancel selector 810 can be used to exit the text input, cancel the entry of a previous input, or other cancel action. The reword input selector 812 can be used to reword or rephrase the currently-selected option 806 or all of the displayed options, similar to the reword input selector 156. The settings selector 814 can be used to access a settings user interface with which the user can change settings for the input system 100. In an example, the settings can include privacy settings that can be used to view what personal information the input system 100 has regarding the user and from which sources of information the input system 100 draws. The privacy settings can also include the ability to turn off data retrieval from certain sources and deleting personal information. In some examples, these settings can be accessed remotely and used to modify the usage of private data or the input system 100 itself, for example, in case the device on which the input system 100 operates is stolen or otherwise compromised. The enter selector 816 can be used to submit input to the communication medium 804. For example, the user can use the input system 100 to input “Best movie trailers,” the user could then access the enter selector 816 to cause the communication medium 804 to search using that phrase.

Returning to the example of FIGS. 7A-H, let's say that the user and Sandy went to eat noodles and the user now wants to learn how to cook some of the dishes they ate at the restaurant. The user access a video tutorial site on the user's smart television, and the user interface for the input system 100 loads to help the user search for video content.

FIG. 8A is an example of what the user may see when using the input system 100 with a video search communication medium 804. Once again, the communication engine 124 takes the user's communication model 122 as input, as well as the communication context data 130 and the pluggable sources 132. Here, the communication context data 130 includes communication medium data 128, which can include popular searches and videos on the video search platform. The user allows the input system 100 to access the user's prior search history and video history, so the communication medium data 128 also includes that information as well. Based on this input, the communication engine 124 generates options to display at the user interface 802. The communication engine 124 determines that “Best” is the most-appropriate input, so it is placed at the center of the user interface as the currently-selected option 806. The user wants to select “Cooking,” so the user moves the selection to “Cooking” using a direction pad on a remote control and chooses that option.

FIG. 8B shows what may be displayed on the screen 800 after the user chooses “Cooking.” The communication engine 124 is aware that the user chose “Cooking” and suggests appropriate options. The user, wanting to learn how to cook a noodle dish, chooses the already-selected “Noodles” option, and uses the enter selector 816 to cause the communication medium 804 to search for “Cooking Noodles.” In this manner, rather than needing to select the individual letters that make up “Cooking Noodles,” the user was able to leverage the capabilities of the input system 100 to input desired information more quickly and easily.

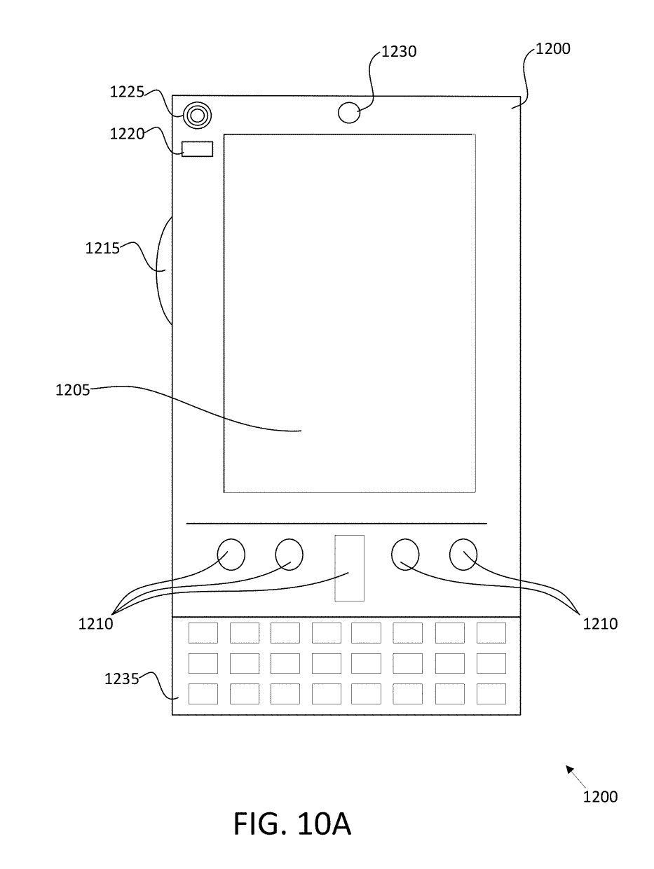

FIG. 9 is a block diagram illustrating physical components (e.g., hardware) of a computing device 1100 with which aspects of the disclosure may be practiced. The computing device components described below may have computer executable instructions for implementing an input system platform 1120, a communication engine platform 1122, and a communication model generator 1124 on a computing device including computer executable instructions for the input system platform 1120, the communication engine platform 1122, and the communication model generator 1124 that can be executed to employ the methods disclosed herein. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 suitable for running the input system platform 1120, the communication engine platform 1122, and the communication model generator 1124 or one or more components in regards to FIG. 1. The operating system 1105, for example, may be suitable for controlling the operation of the computing device 1100. Furthermore, embodiments of the disclosure may be practiced in conjunction with a graphics library, other operating systems, or any other application program and is not limited to any particular application or system. This basic configuration is illustrated in FIG. 9 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 9 by a removable storage device 1109 and a non-removable storage device 1110.

As stated above, a number of program modules and data files may be stored in the system memory 1104. While executing on the processing unit 1102, the program modules 1106 may perform processes including, but not limited to, the aspects, as described herein. Other program modules that may be used in accordance with aspects of the present disclosure, and in particular for providing an input system.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1100 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1100 may also have one or more input device(s) 1112 such as a keyboard, a mouse, a pen, a sound or voice input device, a touch or swipe input device, and other input devices. The output device(s) 1114 such as a display, speakers, a printer, and other output devices may also be included. The aforementioned devices are examples and others may be used. The computing device 1100 may include one or more communication connections 1116 allowing communications with other computing devices 1150. Examples of suitable communication connections 1116 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

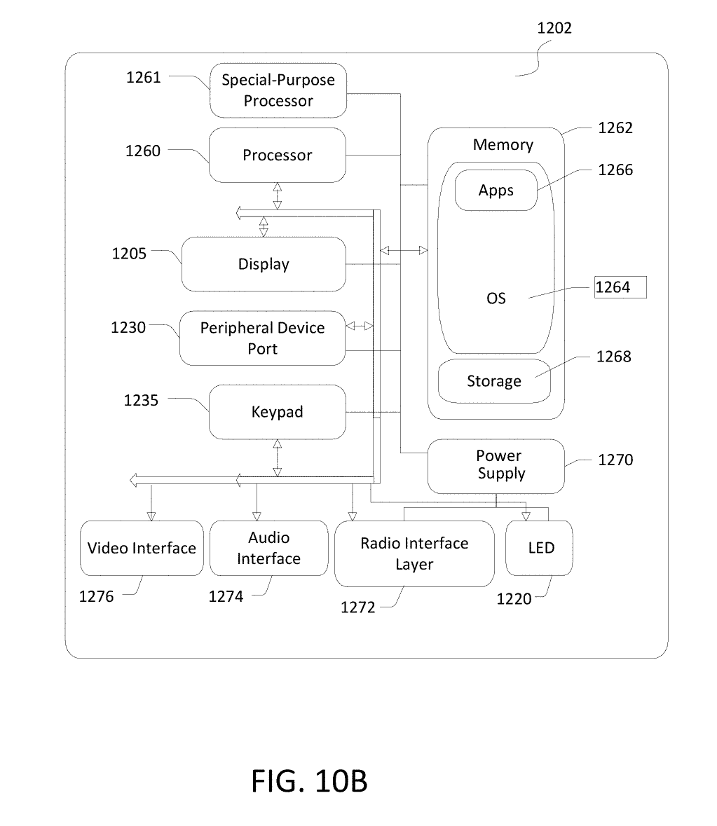

FIG. 10A and FIG. 10B illustrate a mobile computing device 1200, for example, a mobile telephone, a smart phone, wearable computer (such as a smart watch), a tablet computer, a laptop computer, set top box, game console, Internet-of-things device, and the like, with which embodiments of the disclosure may be practiced. In some aspects, the client may be a mobile computing device. With reference to FIG. 10A, one aspect of a mobile computing device 1200 for implementing the aspects is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative aspects, mobile computing device 1200 may incorporate more or less input elements. For example, the display 1205 may not be a touch screen in some embodiments. In yet another alternative embodiment, the mobile computing device 1200 is a portable phone system, such as a cellular phone. The mobile computing device 1200 may also include an optional keypad 1235. Optional keypad 1235 may be a physical keypad or a “soft” keypad generated on the touch screen display (e.g., a virtual input element). In various embodiments, the output elements include the display 1205 for showing a graphical user interface (GUI), a visual indicator 1220 (e.g., a light emitting diode), and/or an audio transducer 1225 (e.g., a speaker). In some aspects, the mobile computing device 1200 incorporates a vibration transducer for providing the user with tactile feedback. In yet another aspect, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 10B is a block diagram illustrating the architecture of one aspect of a mobile computing device. That is, the mobile computing device 1200 can incorporate a system (e.g., an architecture) 1202 to implement some aspects. In one embodiment, the system 1202 is implemented as a “smart phone” capable of running one or more applications (e.g., browser, e-mail, calendaring, contact managers, messaging clients, games, and media clients/players). In some aspects, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as email or other messages used by an email application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including the instructions for providing an input system platform as described herein.

The system 1202 has a power supply 1270, which may be implemented as one or more batteries. The power supply 1270 might further include an external power source, such as an AC adapter or a powered docking cradle that supplements or recharges the batteries.

The system 1202 may also include a radio interface layer 1272 that performs the function of transmitting and receiving radio frequency communications. The radio interface layer 1272 facilitates wireless connectivity between the system 1202 and the “outside world,” via a communications carrier or service provider. Transmissions to and from the radio interface layer 1272 are conducted under control of the operating system 1264. In other words, communications received by the radio interface layer 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated embodiment, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with embodiments of the present disclosure, the microphone may also serve as an audio sensor to facilitate control of notifications, as will be described below. The system 1202 may further include a video interface 1276 that enables an operation of an on-board camera 1230 to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 10B by the non-volatile storage area 1268.

Data/information generated or captured by the mobile computing device 1200 and stored via the system 1202 may be stored locally on the mobile computing device 1200, as described above, or the data may be stored on any number of storage media that may be accessed by the device via the radio interface layer 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio interface layer 1272 or via a distributed computing network. Similarly, such data/information may be readily transferred between computing devices for storage and use according to well-known data/information transfer and storage means, including electronic mail and collaborative data/information sharing systems.

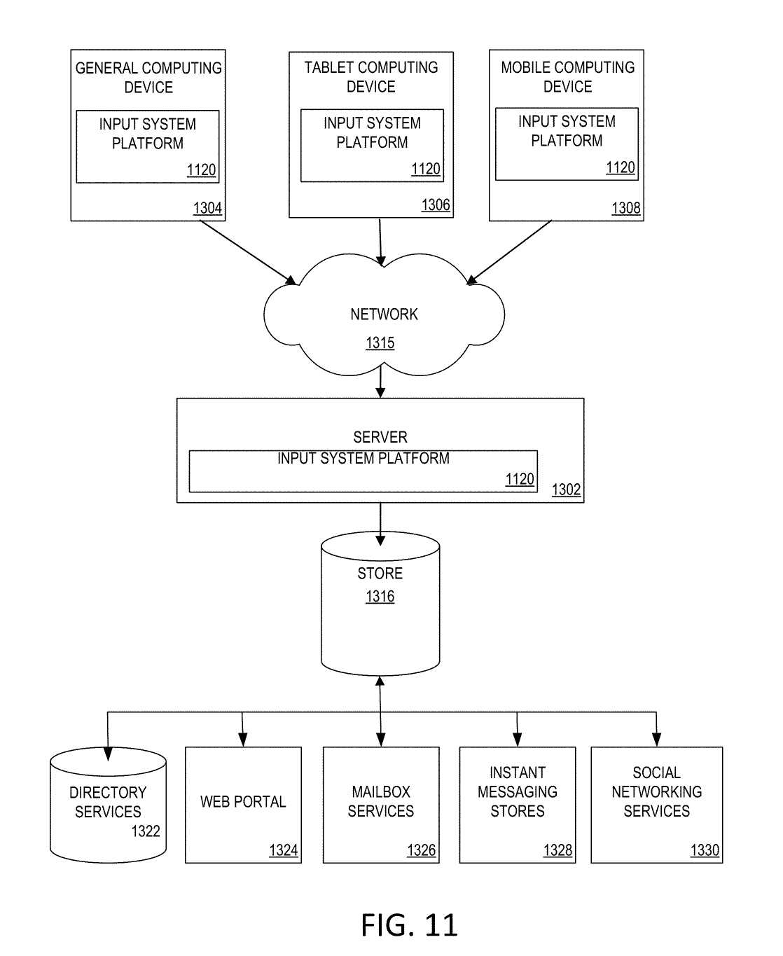

FIG. 11 illustrates one aspect of the architecture of a system for processing data received at a computing system from a remote source, such as a personal computer 1304, tablet computing device 1306, or mobile computing device 1308, as described above. Content displayed at server device 1302 may be stored in different communication channels or other storage types. For example, various documents may be stored using a directory service 1322, a web portal 1324, a mailbox service 1326, an instant messaging store 1328, or a social networking site 1330. The input system platform 1120 may be employed by a client that communicates with server device 1302, and/or the input system platform 1120 may be employed by server device 1302. The server device 1302 may provide data to and from a client computing device such as a personal computer 1304, a tablet computing device 1306 and/or a mobile computing device 1308 (e.g., a smart phone) through a network 1315. By way of example, the computer system described above with respect to FIGS. 1-10B may be embodied in a personal computer 1304, a tablet computing device 1306 and/or a mobile computing device 1308 (e.g., a smart phone). Any of these embodiments of the computing devices may obtain content from the store 1316, in addition to receiving graphical data useable to be either pre-processed at a graphic-originating system, or post-processed at a receiving computing system.

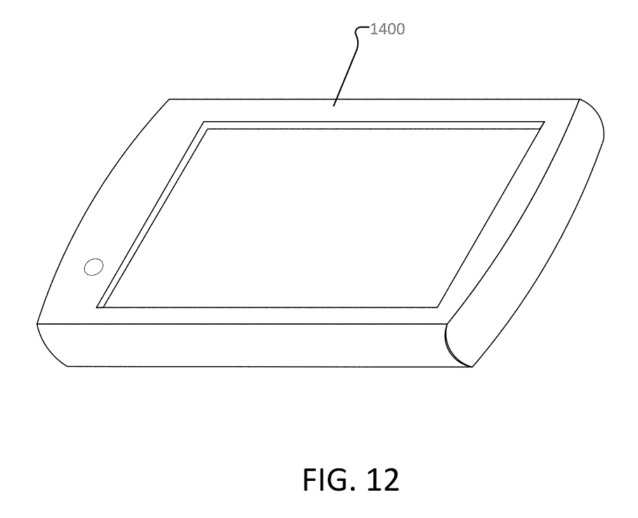

FIG. 12 illustrates an exemplary tablet computing device 1400 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer-implemented method for a virtual input system, the method comprising:
obtaining user data from one or more data sources, the user data indicative of a personal communication style of a user;
generating a user communication model based, in part, on the user data;
obtaining data regarding a current communication context, the data comprising data regarding a communication medium;
generating a plurality of sentences for use in the current communication context based, in part, on the user communication model and the data regarding the current communication context; and
causing the plurality of sentences to be provided to the user for use over the communication medium.

2. The method of claim 1, wherein the plurality of sentences is a first plurality of sentences, and wherein the method further comprises:
receiving a reword command;
responsive to receiving the reword command, generating a second plurality of sentences for use in the current communication context based, in part, on the user communication model and the data regarding the current communication context, wherein at least one of the second plurality of sentences is different from the sentences of the first plurality of sentences.

3. The method of claim 2, further comprising:
updating the user communication model based in part on the received reword command.

4. The method of claim 1, further comprising:
receiving a selection of a word input mode; and
responsive to receiving the selection of the word input mode, generating a first plurality of words, the first plurality of words matching a communication style of the user in the current communication context based on the user communication model; and
causing the plurality of words to be provided to the user for individual selection and use over the communication medium.

5. The method of claim 1, further comprising:
receiving a selection of an alternate communication model; and
wherein generating the plurality of sentences for use in the current communication context is further based, in part, on the alternate communication model.

6. The method of claim 1, wherein generating the user communication model comprises:
generating a diction model for the user; and
generating a syntax model for the user.

7. The method of claim 6, wherein generating the plurality of sentences comprises:
for each sentence of the plurality of sentences, selecting a word of the respective sentence based on the diction model of the user, and selecting the word based on the syntax model of the user.

8. The method of claim 1, wherein the one or more data sources comprise a data source selected from the group consisting of: language corpus data, social media data, communication history data, social media data, and user preferences.

9. The method of claim 1, wherein the data regarding the current communication context comprises data indicating one or more of: a user's location, calendar events of the user, a time of day, a communication target of the communication medium, a current activity of the user, and recent activity regarding the communication medium.

10. The method of claim 1, wherein the communication medium comprises software that enables person to initiate or respond to data transfer.

11. A non-transitory computer-readable medium having computer-executable instructions stored thereon that, when executed by a processor, cause the processor to:
receive a request for input to a communication medium;
obtain a communication context, the communication context comprising data regarding the communication medium;
provide the communication context to a communication engine, the communication engine configured to emulate a communication style of a user;
receive, from the communication engine, a plurality of sentences generated based on the communication context and the communication style of the user; and
make the plurality of sentences available for selection by the user at a user interface as the input to the communication medium.

12. The non-transitory computer-readable medium of claim 11, wherein the instructions further comprise instructions that when executed by the processor cause the processor to:
receive a selected sentence of the plurality of sentences;
receive a send command; and
provide the selected sentence as the input to the communication medium.

13. The non-transitory computer-readable medium of claim 11, wherein the plurality of sentences is a first plurality of sentences, and wherein the instructions further comprise instructions that when executed by the processor cause the processor to:
receive a reword command; and
responsive to receiving the reword command, obtain a second plurality of sentences from the communication engine, the second plurality of sentences generated based on the communication style of the user and the communication context, wherein the second plurality of sentences is different from the first plurality of sentences.

14. The non-transitory computer-readable medium of claim 11, wherein the instructions further comprise instructions that when executed by the processor cause the processor to:
receive, from the communication engine, a plurality of information packages generated based on the communication context and the communication style of the user; and
make the plurality of information packages available for selection by the user at the user interface as the input to the communication medium.

15. The non-transitory computer-readable medium of claim 14, wherein the plurality of information packages comprise an information package selected from the group consisting of: an event from a calendar application, a location from a mapping application, and a contact from a contacts application.

16. A computer-implemented method comprising:
obtaining a first plurality of sentences from a communication engine, the first plurality of sentences matching a communication style in a current communication context based on a communication model, the current communication context comprising a communication medium;
making the first plurality of sentences available for selection by a user over a user interface;
receiving a selection of a sentence of the first plurality of sentences over the user interface;
receiving a reword command from the user over the user interface;
responsive to receiving the reword command, obtaining a second plurality of sentences based on the selected sentence from the communication engine, the second plurality of sentences matching the communication style in the current communication context based on the communication model and at least one of the second plurality of sentences being different from the sentences of the first plurality of sentences; and
making the second plurality of sentences available for selection by the user over the user interface.

17. The method of claim 16, wherein the communication style is a communication style of the user; and wherein the communication model is a communication model of the user.

18. The method of claim 16, further comprising:
receiving a selection of an alternate communication model; and
setting the communication style to an alternate communication style modeled by the alternate communication model; and
setting the communication model to the alternate communication model.

19. The method of claim 16, further comprising:
receiving a selection of a word input mode; and
responsive to receiving the selection of the word input mode, making a first plurality of words available for selection by the user at the user interface, the first plurality of words matching the communication style in the current communication context based on the communication model.

20. The method of claim 16, further comprising:
receiving a selection of a second sentence of the second plurality of sentences;
receiving a send command from the user over the user interface; and
providing the second sentence to the communication medium.
